(19) United States
(12) Patent Application Publication
(10) Pub. No.: US 2011/0170878 A1
(43) Pub. Date: Jul. 14, 2011

(54) APPARATUS AND METHOD FOR GENERATING OPTICAL PULSES

(76) Inventors: Antonella Bogoni, Mantova (IT); Luca Poti, Pisa (IT); Emma Lazzeri, Arcola (sp) (IT); Paolo Ghelfi, Goito (IT)

(21) Appl. No.: 12/995,236

(22) PCT Filed: May 30, 2008
(86) PCT No.: PCT/EP2008/056700

§ 371 Date: Mar. 21, 2011

(51) Int. Cl. H04B 10/04

(52) U.S. Cl. 398/189

(57) ABSTRACT

An apparatus and method for generating a train of optical pulses. The apparatus comprises an optical resonant cavity (1) for confining an optical signal in the cavity to a number of modes, a modulator (3), and a control signal generator (101). The modulator comprises an interferometer arranged to cause interference of the optical signal with itself to produce an output and controllable material, such as an electro-optic crystal, arranged in a path of the optical signal, an optical property of the controllable material dependent on a control signal (3b) applied to the controllable material such that changes in the optical property alter optical signals travelling that path to affect the interference of the optical signals, and therefore the output of the modulator. The control signal generator is arranged to generate the control signal, wherein the control magnitude is an oscillating waveform arranged to cause transmission of the optical signal through the modulator to generate pulses having a pulse width shorter than a pulse width of pulses that would be generated using a sinusoidal waveform of the same frequency.

### TECHNICAL FIELD

This invention concerns apparatus and method for generating optical pulses and in particular, but not exclusively, the generation of a train of ultra-short optical pulses having a pulsewidth of less than 100 ps, and preferably less than 35 ps.

### BACKGROUND

Sources of short pulses at tuneable wavelengths have a number of photonic applications. For example, all-optical multi-wavelength conversion of ultra-short pulses is a key functionality to allow wavelength routing in a hybrid wavelength division multiplexing (WDM)/optical time division multiplexing (OTDM) network while the generation of ultra-short pulse trains is necessary for ultra-fast optical sampling. The generation of pulse trains at a low bit rate has an important role in photonics signal processing techniques that use digital return-to-zero (RZ) signals.

A mode locked laser (MLL) can be used to generate ultra-short pulses. In a mode-locked laser, each mode is controlled to propagate with a fixed phase difference between it and the other modes such that the modes of the laser periodically constructively interfere with one another, producing intense bursts or pulses of light. Such a laser is said to be mode-locked or phase-locked.

FIG. 1 illustrates apparatus for producing a MLL. The MLL comprises a resonant cavity 1 comprising a looped long erbium doped fibre 2 as an active element and a Mach Zehnder electro-optical Modulator (MZM) 3. The MZM 3 can be controlled by a voltage bias (indicated by arrow 3a) and a control signal voltage from a source 3b to produce interference to generate optical pulses in the resonant cavity 1. A laser pump (not shown) is connected to the fibre 2 by an optical coupler 4 for powering the laser resonant cavity 1. An optical delay line 5a can be used to vary the length of the cavity 1 to change the resonant frequency in the resonant cavity 1. An optical filter 5b sets the carrier wavelength of the pulse train. Optical isolator 20 restricts transmission in only one direction (in this embodiment, clockwise) around the fibre 2 of the resonant cavity 1.

The MLL further comprises a 50/50 coupler 7 that splits the signal circulating in the resonant cavity 1 into two portions, such that 50% of the signal intensity is delivered along optical fibre 7. A 90/10 coupler 8 splits the signal on optical fibre 7 such that 90% of the signal intensity is delivered to output 8 and the remaining 10% is delivered to a regenerative feedback loop 6. Feedback loop 6 comprises an optical delay line 9 for controlling the phase of the signal in the feedback loop 6, a photodiode 10 for converting the optical signal into an electrical signal, and means for filtering and amplifying the electrical signal (via a first bandpass filter 11, preamplifier 12, booster amplifier 13, a second bandpass filter 14 and a driver amplifier 15). The bandpass filters 11, 14 have a central frequency equal to a multiple of the cavity 1 resonance frequency and a Q factor that allows the selection of only one mode of the signal. By correctly tuning the MZM 3 bias and the length of the feedback line 6 via the delay line 9, it is possible to mode-lock the laser.

FIG. 2 illustrates an alternative embodiment of a mode locked laser. In this embodiment, the feedback loop 6 is replaced with an electronic section that uses a clock generator 16 to generate the signals for controlling the MZM 3, the clock signal being boosted by an amplifier 19. The clock generator 16 has the same frequency component and RF power as the signal produced by the regenerative feedback loop 6. In this embodiment, only a bias tuning is required to mode lock the laser.

In both embodiments, the MZM control signal (RF clock out 17) is available as an output to be used when required by a particular application. The isolator 18 on the RF clock out 17 prevents electrical reflections that could cause interference.

Referring to FIGS. 3a and 3b, there is shown a MZM 3 utilized in the apparatus of FIGS. 1 and 2. The MZM 3 comprises an optical splitter 21, such as a half silvered mirror, for dividing an optical signal input into the MZM 3 into two portions, each portion for transmission along a respective path 22, 23. The signal portion on each path is then reflected by a mirror 24, 25 to an optical coupler 26, for example a further half silvered mirror, that recombines the two signal portions such that the signals interfere. One of the outputs from the optical combiner 26 is the output Eₒᵤₜ of the MZM 3 and the other is blocked by an optical blocker 27. Located in path 22 is electro-optic crystal 28. The refractive index of the electro-optic crystal 28 is dependent on a voltage potential V_{R}-V_{bias} applied across the crystal such that changes in the refractive index alter the relative phase of the signal portion travelling path 22. Alteration of the phase of the signal travelling path 22 affects the interference of the signal portions at the optical coupler 26 and therefore the output Eₒᵤₜ of the modulator 3.

### SUMMARY

According to a first aspect of the invention there is provided apparatus for generating a train of optical pulses comprising an optical resonant cavity for confining an optical signal in the cavity to a number of modes, a modulator and a control signal generator. The modulator may comprise an interferometer arranged to cause interference of the optical signal with itself to produce an output and controllable material arranged in a path of the optical signal, an optical property of the controllable material dependent on a control signal applied to the controllable material such that changes in the optical property alter optical signals travelling that path to affect the interference of the optical signals in the interferometer, and therefore the output of the modulator. The control signal generator may be arranged to generate the control signal. The control signal may be an oscillating waveform arranged to cause transmission of the optical signal through the modulator to generate pulses having a pulse width shorter than a pulse width of pulses that would be generated using a sinusoidal waveform of the same frequency.

By using a non-sinusoidal waveform for the control signal, the apparatus can generate pulses having a shorter pulse width at a lower frequency.

It will be understood that the term “pulse width” as used herein means the interval between a first time, at which the amplitude of the pulse reaches a level that is a specified fraction of the maximum amplitude of the pulse and a second time, at which the amplitude of the pulse drops to the same level. For example, the pulse width may be the full width at half maximum (FWHM) of the pulse.

The control signal may be an optical, electrical (e.g. a voltage), magnetic or acoustic (e.g. pressure) signal. The controllable material may be anisotropic material. The controllable material may be a crystal, such as an electro-optic crystal, magneto-optic crystal or an acoustic optic crystal.

The optical property of the controllable material may be controlled so as to control the relative phase of the optical signal portions interfering in the interferometer. The optical property may be refractive index. Changes in the refractive index will thereby alter the velocity of optical signals transmitted along the path.

The waveform may rise to a first predetermined potential from a second predetermined potential and may fall from the first predetermined potential to the second predetermined potential faster than a sinusoidal wave of the same frequency, wherein the first and second predetermined potentials are potentials at which there is substantially no transmission of the optical signal through the modulator. The first and second predetermined potentials set the optical property of the controllable material to produce a phase difference of the signals in the interferometer that results in destructive interference in the interferometer to produce substantially zero output from the modulator.

Each magnitude may be a potential, such as a voltage potential.

The waveform may remain substantially at the first predetermined magnitude and substantially at the second predetermined magnitude for a duration longer than would be the case for a sinusoidal wave of the same frequency.

In one embodiment, the waveform has a first portion in which the magnitude rises to the first predetermined magnitude from the second predetermined magnitude; a second portion in which the magnitude is held substantially constant at the first predetermined magnitude; a third portion in which the magnitude decreases from the first predetermined magnitude to the second predetermined magnitude and a fourth portion in which the magnitude is held substantially constant at the second predetermined magnitude.

The apparatus can produce very short optical pulses at a low frequency, with a duration of the optical pulses equal to the rise time and fall time of the waveform (equal to the duration of either one of the first and third portions of the waveform). Accordingly, the more rapidly the waveform increases and falls during the first and third portions, the smaller the width of the pulses.

The first and third portions of the waveform may have a shorter duration than the second and third portions. In one embodiment, the first portion and third portion have a duration of less than 100 ps and preferably, less than 35 ps. In this way, the apparatus may produce ultra short pulses at a low frequency.

The waveform may be a truncated triangular waveform, which for very short rise and fall times (first and third portions) relative to the second and fourth portions can be considered to be substantially a square waveform.

The waveform may be centred on a magnitude at which the output of the modulator is at a peak. For an electro-optic crystal of control voltage is preferably 0V.

The interferometer may be arranged to split the optical signal in the cavity into two paths and then recombine the signals in the paths so as the signals interfere, the controllable material arranged in one of the paths such that changes in optical property alters a phase of signals travelling that path, and therefore the relative phases between the signals in each path, to affect the interference. The modulator is preferably a Mach Zehnder Modulator (which comprises a Mach Zehnder Interferometer). However, it will be understood that it may be possible to use other types of interferometers, such as a Michelson interferometer.

According to a second aspect of the invention, there is provided a method of controlling apparatus for generating a train of optical pulses. The apparatus may comprise an optical resonant cavity for confining an optical signal in the cavity to a number of modes and a modulator. The modulator may comprise an interferometer arranged to cause interference of the optical signal with itself to produce an output of the modulator and controllable material arranged in a path of the optical signal, an optical property of the controllable material dependent on a control signal applied to the controllable material such that changes in the optical property alter optical signals travelling that path to affect the interference of the optical signals, and therefore the output of the modulator. The method may comprise applying the control signal to the controllable material, wherein the control signal is an oscillating waveform arranged to cause transmission of the optical signal through the modulator to generate pulses having a pulse width shorter than a pulse width of pulses that would be generated using a sinusoidal waveform of the same frequency.

The controllable material may be an electro-optic crystal and the apparatus may comprise a driver amplifier that generates a control voltage applied to the electro-optic crystal and the method comprises generating a high A.C. power signal for driving the driver amplifier, the high power signal arranged such that it saturates the gain of the driver amplifier. By saturating the gain of the driver amplifier, the output of the driver amplifier comprises portions (corresponding to the second and fourth portions of the waveform) of constant power (equal to the maximum power output of the driver amplifier).

According to a third aspect of the invention there is provided a controller for generating a control magnitude for apparatus comprising an optical resonant cavity for confining an optical signal in the cavity to a number of modes and a modulator. The modulator may comprise an interferometer arranged to cause interference of the optical signal with itself to produce an output of the modulator and controllable material arranged in a path of the optical signal, an optical property of the controllable material dependent on a control signal applied to the controllable material such that changes in the optical property alter optical signals travelling that path to affect the interference of the optical signals, and therefore the output of the modulator. The controller may be arranged to be connected to the apparatus to apply a control signal to the controllable material, the control magnitude comprising an oscillating waveform arranged to cause transmission of the optical signal through the modulator to generate pulses having a pulse width shorter than a pulse width of pulses that would be generated using a sinusoidal waveform of the same frequency.

The controllable material may be an electro-optic crystal and the apparatus and/or controller may comprise a driver amplifier that generates the control voltage applied to the electro-optic crystal and the controller generates a high A.C. power signal for driving the driver amplifier, the high power signal arranged such that it saturates the gain of the driver amplifier. By saturating the gain of the driver amplifier, the output of the driver amplifier comprises portions (corresponding to the second and fourth portions of the waveform) of constant power (equal to the maximum power output of the driver amplifier).

The controller may be a regenerative feedback loop that uses optical signals produced in the cavity as a source for the high A.C. power signal. For example, the feedback loop may remove a proportion of the optical signal from the cavity and amplify and, optionally filter, the signal before using the amplified signal as the high A.C. power signal for driving the driver amplifier. Alternatively, the controller may comprise a voltage generator that originates the high A.C. power signal and/or control voltage.

According to a fourth aspect of the invention there is provided a data carrier comprising instructions that, when executed by a processor of a controller, causes the controller to operate in accordance with the third aspect of the invention.

According to a fifth aspect of the invention there is provided apparatus for generating a train of optical pulses comprising an optical resonant cavity for confining an optical signal in the cavity to a number of modes, a Mach Zehnder Modulator for modulating signals travelling in the cavity and a control signal generator for supplying a control voltage to the Mach Zehnder Modulator, wherein the control signal is an oscillating waveform arranged to cause transmission of the optical signal through the modulator to generate pulses having a pulse width shorter time than a pulse width of pulses that would be generated using a sinusoidal waveform of the same frequency.

According to a sixth aspect of the invention there is provided a pulse generator comprising a plurality of the above apparatus connected together such that pulses generated by the apparatuses are interleaved to generate a train of pulses.

### BRIEF DESCRIPTION OF DRAWINGS

Embodiments of the invention will now be described, by example only, with reference to the accompanying drawings, in which:—

FIG. 1 shows one embodiment of apparatus for generating a mode locked laser in accordance with the prior art;

FIG. 2 shows another embodiment of apparatus for generating a mode locked laser in accordance with the prior art;

FIG. 3a shows the Mach Zehnder Modulator (MZM) as used in the apparatus shown in FIGS. 1 and 2;

FIG. 3b shows a schematic view of the Mach Zehnder Modulator as used in the apparatus shown in FIGS. 1 and 2;

FIG. 4 are graphs showing the transmittance through the MZM for the control voltage shown;

FIG. 5 shows apparatus in accordance with an embodiment of the invention;

FIG. 6 shows a control voltage and resulting transmission function in accordance with an embodiment of the invention;

FIG. 7 shows an example of a control voltage and a resultant pulse generated by apparatus according to an embodiment of the invention;

FIG. 8 is a graph of pulse width verses driver amplifier input power for apparatus in accordance with an embodiment of the invention;

FIG. 9 is a flowchart of a method in accordance with an embodiment of the invention; and

FIG. 10 shows a plurality of apparatuses according to an embodiment of the invention linked together such that pulses generated by the apparatuses are interleaved to generate a train of pulses.

### DETAILED DESCRIPTION

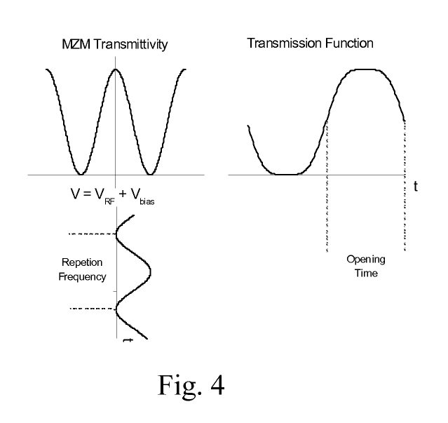

FIG. 4 is a graph illustrating the transmittance of the MZM 3 for control signal voltages V=V_{RF}+V_{bias}. Transmittivity is equal to

$$\frac{{\vert {E}_{in} \vert}^{2}}{{\vert {E}_{out} \vert}^{2}} ,$$

wherein Eᵢₙ is equal to the intensity of the optical signal fed into the MZM 3 and Eₒᵤₜ is the output intensity of the MZM 3. As can be seen from FIG. 4, the transmittivity varies as a cosine relationship with the control voltage. When the control voltage is equal to ±(2n+1)V_{π}, wherein n=0,1, . . . , the optical output Eₒᵤₜ is zero while when the control voltage is equal to ±2mV_{π}, wherein m=0,1, . . . , the optical output Eₒᵤₜ is equal to Eᵢₙ, the transmittivity varying continuously between these extremes. Accordingly, when V_{RF}, is a sinusoidal signal at a frequency that is equal to a multiple of the cavity resonant frequency, the transmission function is a series of peaks having a pulse-width (opening time/switch on state) equal to half the wavelength of the control signal and a repetition rate that is equal to the repetition of the control signal.

The duration of the opening time/switch on-state is in inverse proportion to the control signal frequency, i.e. the lower the frequency the longer the opening time/switch on-state. As a consequence, the pulses generated by low frequency signals can be too long.

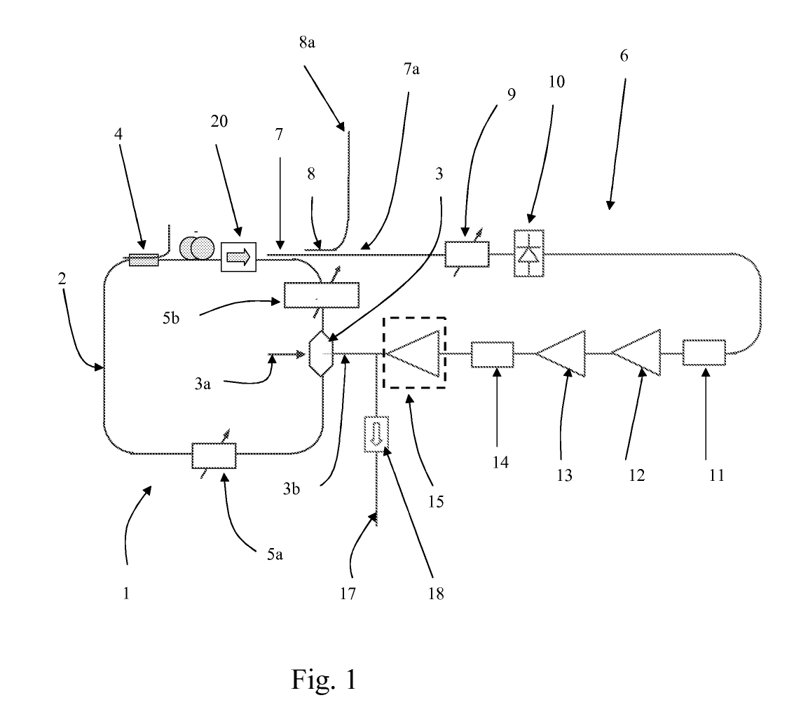

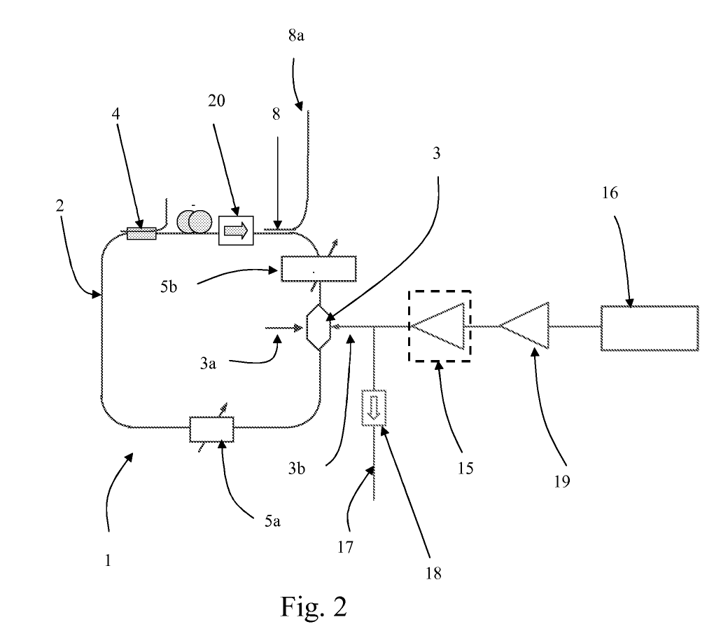

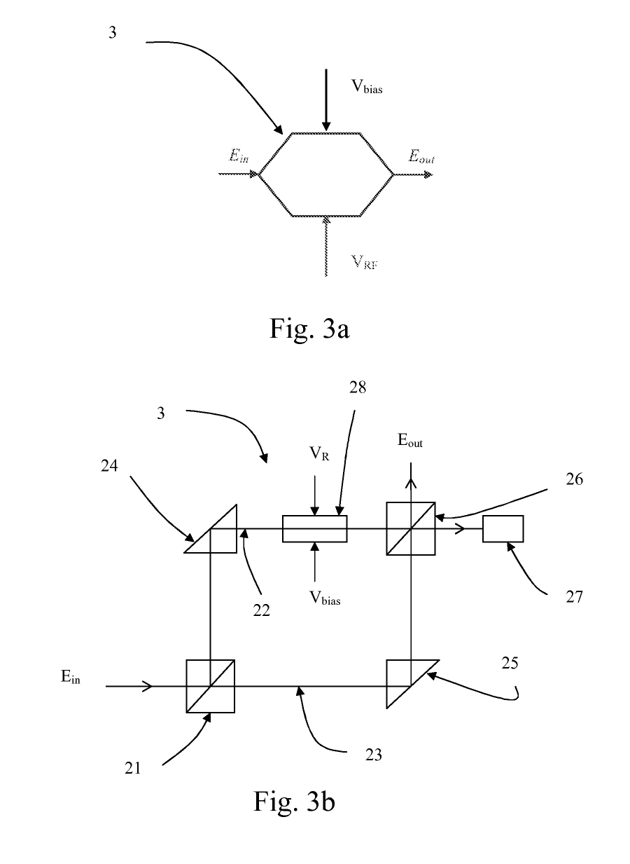

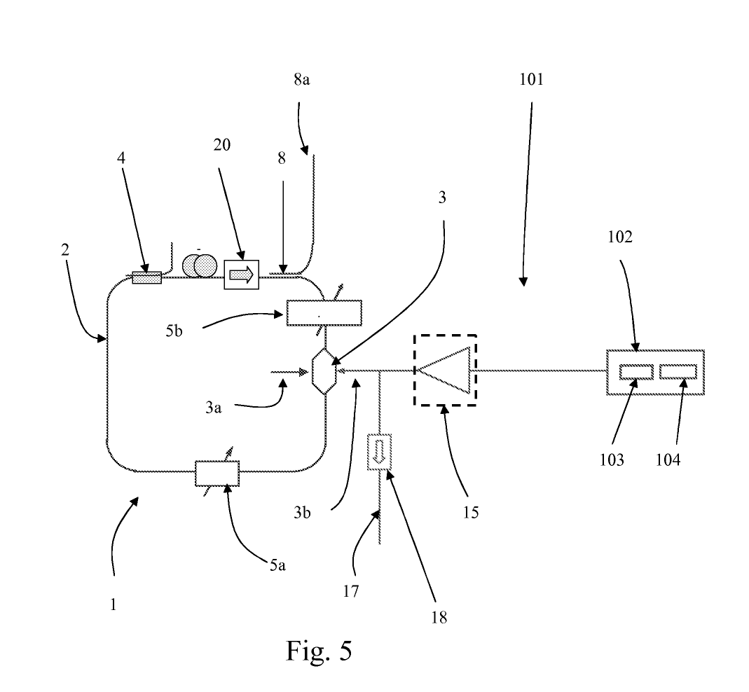

Referring to FIG. 5, apparatus for generating a train of optical pulses in accordance with one embodiment of the invention is shown. Features of this apparatus that are the same or similar to features of the apparatus shown in FIGS. 1 and 2 have been given the same reference numerals and will not be described again in detail.

The apparatus comprises an optical resonant cavity 1 for confining an optical signal in the cavity to a number of optical modes. The resonant cavity 1 comprises a looped erbium doped fibre 2 as an active element and modulator 3, in this embodiment a Mach Zehnder electro-optical Modulator (MZM). The MZM 3 comprises a Mach Zehnder interferometer arranged to cause interference of an optical signal with itself to produce an output and a material having a controllable optical property (e.g. an electro-optic crystal 28, such as a lithium-niobate crystal), arranged in at least one of the paths 22 of the interferometer. The controllable optical property can be the refractive index of the material, controlled by altering the magnitude of a control signal applied to the material. For example, the refractive index of an electro-optic crystal is dependent on the voltage applied thereto, such that changes in the refractive index alter the velocity (and hence the relative phase) of signals travelling that path. Changing the phase of the signal portion travelling along the path 22 of the interferometer affects whether the interference of the signal with the other portion of itself (e.g the portion travelling along path 23) is constructive or destructive, and therefore the output from the modulator 3. It will be understood that in other embodiments, other types of interferometers and other means, such as other optical controllable materials, for altering the interference of the signals in the interferometer may be used.

The resonant cavity 1 further comprises a coupler 4 that couples a laser pump (not shown) to the fibre 2 for powering the laser resonant cavity 1 and an optical delay line 5a to vary the length of the fibre 2 to change the resonant frequency in the resonant cavity 1. An optical filter 5 sets the carrier wavelength of the pulse train. Optical isolator 20 restricts transmission in only one direction (in this embodiment, clockwise) around the loop of the resonant cavity 1.

The apparatus further comprises a 50/50 coupler 7 that splits the signal circulating in the resonant cavity 1 such that 50% of the signal intensity is delivered along optical fibre 8 to an output 8a.

A control signal generator 101 is arranged for applying a control signal voltage to the MZM 3 (across the electic-optic crystal 28 of the MZM). The control signal generator 101 comprises a driver amplifier 15 and a controller 102 for applying a high power A.C. input signal to the driver amplifier 15. It will be understood that in this embodiment the driver amplifier 15 is shown separate from the controller 102, however it will be understood that in another embodiment, the driver amplifier is part of the controller 102.

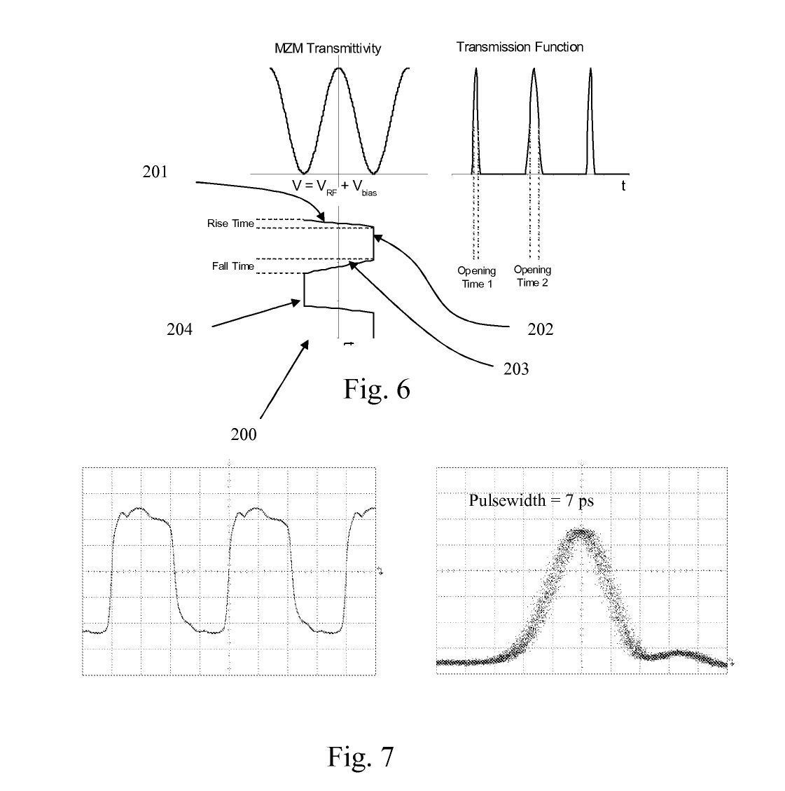

The controller 102 is arranged to generate a signal that saturates the gain of the driver amplifier 15. By saturating the gain of the driver amplifier 15, the output of the driver amplifier 15 generates a voltage V_{RF} approximating the waveform 200 shown in FIG. 6 (V=V_{RF}, V_{bias} is zero).

As can be seen from FIG. 6, the control signal voltage V is an oscillating waveform arranged to cause transmission of the optical signal through the modulator 3 for a shorter time than a sinusoidal waveform of the same frequency.

The saturation voltage of the driver amplifier 15 is set such that the waveform produced oscillates around 0V between a first predetermined voltage and a second predetermined voltage, wherein the first and second predetermined voltages are voltages which set the MZM 3 in a condition where there is no transmission of the optical signal through the MZM 3 (i.e. the first and second predetermined voltages are voltages which set the refractive index of the electro-optic crystal 28 to produce a phase difference of the signals in the interferometer result in destructive interference in the interferometer to produce substantially zero output from the modulator).

As can be appreciated from FIG. 6, the waveform has a truncated triangular shape with first portion 201 that rises linearly from the second predetermined voltage to the first predetermined voltage faster than a sinusoidal wave of the same frequency. During a second portion 202, the waveform remains substantially constant at the first predetermined voltage before, during a third portion 203, the waveform falls linearly from the first predetermined voltage to the second predetermined voltage faster than a sinusoidal wave of the same frequency. During a fourth portion 204, the waveform remains constant at the second predetermined voltage. For very fast rise and fall times, such as 35 ps or less, the truncated triangular shape approximates a square wave. The first and third portions 201, 203 of the waveform have a shorter duration than the second and third portions 202, 204.

It will be understood that it is preferable that during the second and third portions the waveform remains constant at the first and second predetermined voltages respectively, however it will be understood that in other embodiments of the invention, small deviations from the first and second predetermined voltages may be acceptable (or at least an inevitable result of unavoidable fluctuations in the apparatus). An advantage is achieved because the waveform remains substantially at the first and second predetermined voltages for a duration longer than would be the case for a sinusoidal wave of the same frequency.

It will be also understood that it is not necessary that the rise and fall of the waveform is linear but the embodiments of the invention can also utilise waveforms with variable rates of increase/decrease.

The apparatus can produce very short optical pulses (pulses having a width of less then 35 ps) at a low frequency, with a duration of the optical pulses equal to the rise time and fall time of the waveform (equal to the duration of either one of the first and third portions 201, 203 of the waveform). Accordingly, the more rapidly the waveform increases and falls during the first and third portions 201, 203, the smaller the width of the pulses.

FIG. 7 shows an optical pulse produced using the apparatus in accordance with an embodiment with a driver amplifier output having a frequency of 500 MHz. The optical pulse has a pulsewidth of Ips and a measured jitter of <70 fs for the range of >1 KHz.

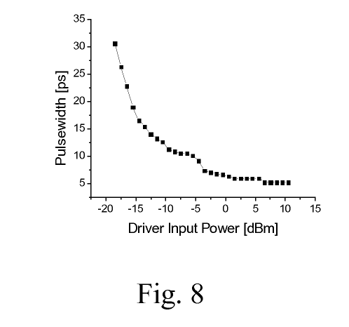

By varying the average power of the signal input to the driver amplifier 15, it is possible to tune the pulsewidth. FIG. 8 shows the variation of pulsewidth with driver amplifier input power. The pulsewidth increases as the driver amplifier input power decreases. For an input power higher than 6.5 dBm, the curve saturates and no further shrinkage of the pulsewidth occurs.

In one embodiment, as indicated in FIG. 5, the controller 102 may comprise a microprocessor 103 that is programmed to operate in accordance with an embodiment of the invention. The microprocessor 103 may operate according to firmware and/or software instructions. Instructions for execution of the microprocessor 103 can be stored on a data carrier 104. The data carrier 104 can be any data carrier capable of storing the instructions, including a memory permanently coupled to the microprocessor, or a removable data carrier such as a CD, DVD, memory stick, or any portable memory device.

It will be understood that in other embodiments of the invention, the apparatus may comprise a regenerative feedback loop 6 as shown in FIG. 1 or a clock generator and, optionally, amplifier 19, as shown in FIG. 2, that act as a controller for driving the driver amplifier 15. In the case of a regenerative loop 6, the preamplifier 12 and the booster amplifier 13 are set (either preset or regularly up-dated automatically to output a required power to achieve a desired pulsewidth). It will be understood that the preferable embodiment comprises a preamplifier 12 and a booster amplifier 13, but in another embodiment, only a single amplifier may be used. Furthermore, bandpass filters 11 and 14 are preferable, as they reduce the noise of the signals before and after amplification, however it will be understood that other types of filters (such as combinations of low and/or high pass filters) may be used or even no filters at all.

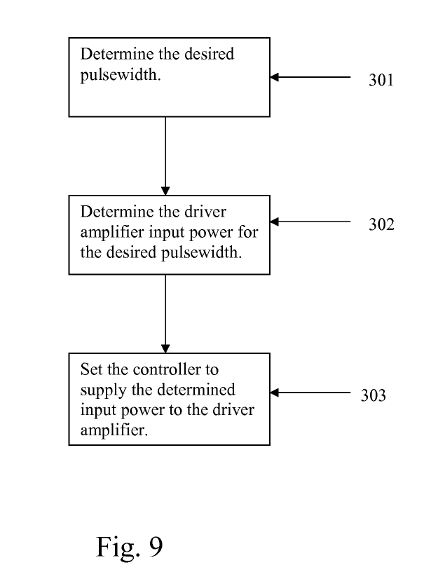

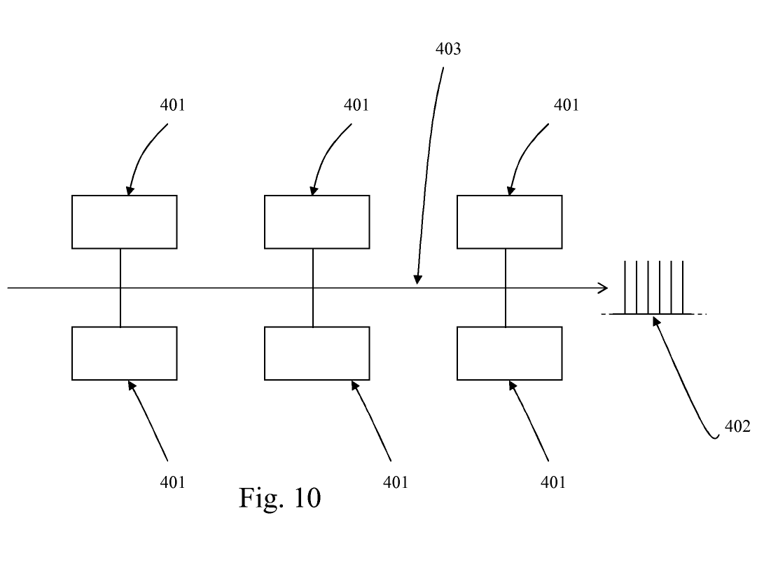

Now referring to FIG. 9, a method of controlling apparatus for generating a train of optical pulses, as shown in FIGS. 1 and 2 comprises applying a control voltage across the electro-optic crystal 28 of the MZM 3, wherein the control signal is an oscillating waveform, such as waveform 200, that causes transmission of the optical signal through the modulator for a shorter time than a sinusoidal waveform of the same frequency.

The method may comprise, in step 301, determining the desired pulsewidth and, in step 302, determining the input power that needs to be applied to the driver amplifier 15 to achieve a waveform that results in the MZM 3 outputting pulses having the desired pulsewidth. In step 303, the method comprises setting the preamplifier 12 and the booster amplifier 13, in the case of apparatus according to FIG. 1, or setting amplifier 19, in the case of apparatus according to FIG. 2, to output a signal having that power such that the required control voltage is applied to the electro-optic crystal 28 of the MZM 3.

FIG. 10 shows a system comprising a plurality of apparatus 401 for generating optical pulses, each apparatus coupled to a multiplexer 403. Each apparatus 401 can be an apparatus as described with reference to FIG. 5. The system is arranged such that the pulses generated by each apparatus 401 are transmitted to the multiplexer 403, for interleaving with the pulses generated by the other apparatuses 401. This produces a train of pulses 402. Such an arrangement may be advantageous as it can be arranged to generate a train of pulses 402 in which the pulses are spaced closer together (i.e. have a higher repetition frequency) than using a single apparatus 401 alone.

1. Apparatus for generating a train of optical pulses comprising:
an optical resonant cavity for confining an optical signal in the cavity to a number of modes;
a modulator comprising an interferometer arranged to cause interference of a portion of the optical signal with another portion of the optical signal to produce an output interference signal from the modulator;
controllable material arranged in a path of at least one of said portions of the optical signal, an optical property of the controllable material dependent on a control signal applied to the controllable material such that changes in the optical property alter optical signals travelling that path to affect the interference of the optical signal portions in the interferometer to thereby affect the output interference signal from the modulator; and
a control signal generator arranged to generate the control signal, the control signal having an oscillating waveform arranged to cause transmission of the optical signal through the modulator to generate pulses having a pulse width shorter than a pulse width of pulses than would be generated using a sinusoidal waveform of the same frequency.

2. Apparatus according to claim 1, wherein the pulse width is a full width at half maximum (FWHM) of the pulse.

3. Apparatus according to claim 1, wherein the waveform rises to a first predetermined magnitude from a second predetermined magnitude and falls from the first predetermined magnitude to the second predetermined magnitude faster than a sinusoidal wave of the same frequency, wherein the first and second predetermined magnitudes are magnitudes at which there is substantially no transmission of the optical signal through the modulator.

4. Apparatus according to claim 3, wherein the waveform remains substantially at the first predetermined magnitude and substantially at the second predetermined magnitude for a duration longer than would be the case for a sinusoidal wave of the same frequency.

5. Apparatus according to claim 3, wherein the waveform has a first portion in which the magnitude rises to the first predetermined magnitude from the second predetermined magnitude; a second portion in which the magnitude is held substantially constant at the first predetermined magnitude; a third portion in which the magnitude decreases from the first predetermined magnitude to the second predetermined magnitude and a fourth portion in which the magnitude is held substantially constant at the second predetermined magnitude.

6. Apparatus according to claim 5, wherein the first and third portions of the waveform have a shorter duration than the second and third portions.

7. Apparatus according to claim 1, wherein the waveform is a truncated triangular waveform.

8. Apparatus according to claim 1, wherein the oscillating waveform is centred on a magnitude at which the output of the modulator is at a peak.

9. Apparatus according to claim 1, wherein the optical property of the controllable material is refractive index and changes in the refractive index alter a phase of the signals travelling that path.

10. Apparatus according to claim 9, wherein the controllable material is an anisotropic material.

11. Apparatus according to claim 10, wherein the controllable material is an electro-optic crystal and the control signal is a control voltage.

12. Apparatus according to claim 11, wherein the modulator is a Mach Zehnder Modulator.

13. Apparatus according to claim 11, wherein the control signal generator comprises a driver amplifier that generates the control voltage applied to the electro-optic crystal and a controller for generating a high A.C. power signal for driving the driver amplifier, the high power signal arranged such that it saturates the gain of the driver amplifier.

14. A method of controlling apparatus for generating a train of optical pulses, the apparatus comprising an optical resonant cavity for confining an optical signal in the cavity to a number of modes and a modulator, the modulator comprising an interferometer arranged to cause interference of the optical signal with itself to produce an output and controllable material arranged in a path of the optical signal, an optical property of the controllable material dependent on a control signal applied to the controllable material such that changes in the optical property alter optical signals travelling that path to affect the interference of the optical signals, and therefore the output of the modulator, the method comprising applying a control signal to the controllable material, wherein the control signal is an oscillating waveform arranged to cause transmission of the optical signal through the modulator to generate pulses having a pulse width shorter than a pulse width of pulses that would be generated using a sinusoidal waveform of the same frequency.

15. A method of claim 14, wherein controllable material is an electro-optic crystal and the apparatus comprises a driver amplifier that generates a control voltage applied to the electro-optic crystal and the method comprising generating a high A.C. power signal for driving the driver amplifier, the high power signal arranged such that it saturates the gain of the driver amplifier.

16. A controller for generating a control voltage for apparatus comprising an optical resonant cavity for confining an optical signal in the cavity to a number of modes and a modulator comprising an interferometer arranged to cause interference of the optical signal with itself to produce an output and controllable material arranged in a path of the optical signal, an optical property of the controllable material dependent on a control signal applied to the controllable material such that changes in the optical property alter optical signals travelling that path to affect the interference of the optical signals, and therefore the output of the modulator, the controller arranged to be connected to the apparatus to apply a control signal to the controllable material, the control signal being an oscillating waveform arranged to cause transmission of the optical signal through the modulator to generate pulses having a pulse width shorter than a pulse width of pulses that would be generated using a sinusoidal waveform of the same frequency.

17. A controller according to claim 16, wherein the controllable material is an electro-optic crystal and the apparatus comprises a driver amplifier that generates the control voltage applied to the electro-optic crystal and the controller generates a high A.C. power signal for driving the driver amplifier, the high power signal arranged such that it saturates the gain of the driver amplifier.

18. A controller according to claim 16, wherein the controller is a regenerative feedback loop that uses optical signals produced in the cavity as a source for the high A.C. power signal.

19. A controller according to claim 16, wherein the controller comprises a voltage generator that originates the high A.C. power signal and/or control voltage.

20.-21. (canceled)
